(19) United States
(12) Patent Application Publication
(10) Pub. No.: US 2021/0047589 A1
(43) Pub. Date: Feb. 18, 2021

(54) HARVEST/POST HARVEST WASH COMPOSITION FOR FLOWERING PLANTS AND A METHOD OF USING THE SAME

(71) Applicant: PH2O, LLC, Athens, AL (US)

(72) Inventors: Dustin Cook, Athens, AL (US); Crissy LeBlanc, Prairieville, LA (US); Catherine Fogliano, Southlake, TX (US); Jason Edward Warf, Colorado Springs, CO (US); Jay Crick, Colorado Springs, CO (US); Clay Pearson, Ashland, OR (US); Allan Ragan, Hartselle, AL (US); Miranda Cook, Athens, AL (US); Jay C. Crick, Colorado Springs, CO (US)

(21) Appl. No.: 16/992,965

(22) Filed: Aug. 13, 2020

Related U.S. Application Data
(60) Provisional application No. 62/886,303, filed on Aug. 13, 2019.

(51) Int. Cl. C11D 3/30; C11D 11/00; C11D 3/39; C11D 3/00; C11D 3/20; C11D 3/33; C11D 3/10; C11D 1/12; C11D 1/66

(52) U.S. Cl. CPC C11D 3/30; C11D 11/0023; C11D 3/3942; C11D 3/0047; C11D 3/2082; C11D 3/0026; C11D 3/10; C11D 1/12; C11D 1/66; C11D 1/123; C11D 3/33

(57) ABSTRACT

The present invention discloses a harvest/post-harvest composition for washing flowering plants and a method of using the same. The composition includes a solution of Tetraacetylethylenediamine (TAED) and sodium percarbonate in a ration ranging from 1:1 to 3:1, respectively. The composition also includes a chelating agent and a pH regulator, which work to activate the TAED; and a surfactant. The pH regulator and the surfactant are added in quantity as minimal as possible to avoid foaming entirely or to produce negligible foaming.

### RELATED APPLICATIONS

This application claims priority from U.S. Provisional Application No. 62/886,303 filed on Aug. 13, 2019 and entitled “Pure Harvest/Post Harvest Wash Composition for Flowering Plants and A Method for Preparing Thereof,” the entire contents of which are hereby fully incorporated herein.

### FIELD OF INVENTION

The present invention relates generally to washing compositions for flowering plants. More particularly, the present invention relates to a harvest/post-harvest wash composition for flowering plants and a method for preparing the same.

### BACKGROUND OF THE INVENTION

Flowering plants naturally accumulate a variety of microbes from the air, soil, water and/or chemicals from pesticides or fungicides, that they are exposed to while they are grown. This accumulation of microbes can be a problem when the flowering plant is later used in oils, medicines, juices or recreational drugs, such as Cannabis—a genus of flowering plants in the family Cannabaceae. Flowering plants that are used in such products need to be washed thoroughly to get rid of the microbes present on them prior to human use or consumption. Unfortunately, rinsing flowering plants with a simple solution of water does not eliminate microbes. Additionally, in many instances, the end-user of the flowering plant does not wash it prior to use or consumption, such as with recreational cannabis users. Many commercially grown flowering plants are also selectively bred to be as resinous as possible when they are flowering and this contributes to an accumulation of microbes. The structures associated with flowering (that are meant to capture pollen) also capture dirt, debris, manure particles, pollen from other types of plants, and other contaminants.

Traditionally, hydrogen peroxide has been used as a plant wash solution because it doesn't damage plant material or associated oils, however in its stabilized (liquid) form hydrogen peroxide is unwieldy and expensive to ship. High parts per million (“PPM”) hydrogen peroxide is also dangerous and requires special handling instructions. Additionally, its disinfecting potential is limited without the addition of a “bleach booster” and its cleaning potential is limited without a surfactant or chelating agent.

Therefore, there exists a need for developing an effective, specialized version of hydrogen peroxide designed specifically for the delicate nature of washing flowering plants, such as cannabis, to remove microbes at the time of harvest or post-harvest that won't damage the plant material and effectively delay decay of the plant from an accumulation of microbes.

### SUMMARY OF THE INVENTION

The present invention has been made in view of the above industry-wide problems, and the present invention discloses a harvest/post-harvest composition for washing flowering plants. The composition includes a solution of Tetraacetylethylenediamine (TAED) and sodium percarbonate at least in a ratio of 1:1 to 3:1 respectively. The composition also includes a chelating agent and a pH regulator, to activate the TAED; and a surfactant. The pH regulator and the surfactant are added in a quantity as minimal as possible to avoid foaming entirely or to produce negligible foaming.

In another embodiment, the present invention discloses a harvest/post-harvest composition for washing Cannabis. The composition includes a solution of Tetraacetylethylenediamine (TAED) and sodium percarbonate at least in a ratio of 1:1 to 3:1 respectively. The composition also includes a chelating agent and a pH regulator, to activate the TAED, and a surfactant. The pH regulator and the surfactant are added in quantity as minimal as possible to avoid foaming entirely or to produce negligible foaming.

In yet another embodiment, the present invention discloses a method for preparing a harvest/post-harvest composition for washing flowering plants. The method comprises mixing a solution of Tetraacetylethylenediamine (TAED) and sodium percarbonate at least in a ratio of 1:1 to 3:1 respectively. The method further involves adding a chelating agent, a pH regulator and a surfactant in such a quantity as to cause no or negligible foaming. Finally, the method involves soaking the flowering plant at the time of harvest or post-harvest in this composition, followed by soaking the flowering plant in water. In a particular embodiment, the soak time in both solutions is twenty minutes. Reduction of microbials occurs after this dual soaking procedure.

### BRIEF DESCRIPTION OF DRAWINGS

Other objects, features, and advantages of the invention will be apparent from the following description when read with reference to the accompanying drawings. In the drawings, wherein like reference numerals denote corresponding parts throughout the several views:

FIG. 1 illustrates a flowchart depicting steps of a method for preparing a harvest/post-harvest wash composition for flowering plants, in accordance with an embodiment of the present invention.

### DETAILED DESCRIPTION

Reference will now be made in detail to particular embodiments of the present invention, examples of which are illustrated in the accompanying drawings.

In the following detailed description, numerous specific details are set forth in order to provide a thorough understanding of the invention. However, it will be understood by those of ordinary skill in the art that the invention may be practiced without these specific details. In other instances, well known methods, procedures and/or components have not been described in detail so as not to obscure the invention.

The invention will be more clearly understood from the following description of the compositions and methods thereof, given by way of example only with reference to the accompanying drawings. In the descriptions that follow, like numerals represent like elements in all figures. For example, where the numeral (2) is used to refer to a particular element in one figure, the numeral (2) appearing in any other figure refers to the same element.

As flowering plants accumulate microbes and also pesticides or fungicides, they require a thorough cleaning to remove those agents. The present invention provides a complete plant washing solution and methods of using it to remove microbes and other contaminants from the flowering plants more efficiently as compared to that of the general and infrequently used washing solutions such as water and hydrogen peroxide.

The present invention discloses a harvest/post-harvest composition for washing flowering plants. The composition includes a solution of Tetraacetylethylenediamine (TAED) and sodium percarbonate in a ratio ranging from 1:1 to 3:1 respectively. The composition also includes a chelating agent and a pH regulator that work to activate the TAED; and a surfactant. The pH regulator and the surfactant are added in a quantity as minimal as possible to avoid foaming altogether or to produce negligible foaming. In some embodiments, the flowering plant is Cannabis. In other embodiments, the chelating agent is Citric acid or EDTA; the pH regulator is potassium bicarbonate or malic acid; and the surfactant is Sodium Lauryl Sulfate (SLS), Sodium Lauryl Sulfoacetate (SLSA,) Sodium Laureth Sulfate (SLES,) yucca extract, Disodium Laureth Sulfosuccinate, or sodium coco sulfate.

In another embodiment, the present invention discloses a harvest/post-harvest composition for washing Cannabis. The composition includes a solution of Tetraacetylethylenediamine (TAED) and sodium percarbonate percarbonate in a ratio ranging from 1:1 to 3:1 respectively. The composition also includes a chelating agent and a pH regulator, that function to activate the TAED; and a surfactant. In other embodiments, the chelating agent is Citric acid or EDTA; the pH regulator is potassium bicarbonate or malic acid; and the surfactant is Sodium Lauryl Sulfate (SLS), Sodium Lauryl Sulfoacetate (SLSA,) Sodium Laureth Sulfate (SLES,) yucca extract, Disodium Laureth Sulfosuccinate, or sodium coco sulfate. The pH regulator and the surfactant are added in quantity as minimal as possible to avoid foaming entirely or to produce negligible foaming.

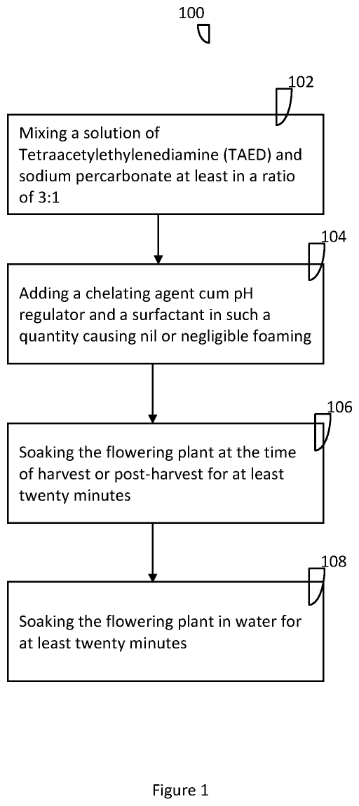

In yet another embodiment, the present invention discloses a method (100) for preparing a harvest/post-harvest composition for washing flowering plants as shown in FIG. 1. The method (100) comprises mixing a solution of Tetraacetylethylenediamine (TAED) and sodium percarbonate in a ratio ranging from 1:1 to 3:1 respectively at step (102). The method (100) further involves adding a chelating agent, a pH regulator and a surfactant in such a quantity as minimal as possible to avoid foaming entirely or to produce negligible foaming at step (104). Finally, the method (100) involves soaking the flowering plant at the time of harvest or post-harvest for at least twenty minutes at step (106), followed by soaking the flowering plant in water for at least twenty minutes at step (108). Reduction of microbials therein initiates after this dual-soak thereof.

While particular embodiments of the present invention have been described above in the Detailed Description, the invention is not limited there to but only by the scope of the appended claim.

As will be readily apparent to those skilled in the art, the present invention may easily be produced in other specific forms without departing from its essential characteristics. The present embodiments are, therefore, to be considered as merely illustrative and not restrictive, the scope of the invention being indicated by the claims rather than the foregoing description, and all changes which come within therefore intended to be embraced therein.

1. A harvest/post-harvest composition for washing flowering plants, the composition comprising:
a solution of Tetraacetylethylenediamine (TAED) and sodium percarbonate in a ratio ranging from 1:1 to 3:1 respectively;
a chelating agent;
a pH regulator; and
a surfactant;
wherein the pH regulator and surfactant are added in a quantity as minimal as possible to avoid foaming entirely or to produce negligible foaming.

2. The composition of claim 1, wherein the chelating agent is selected from the group consisting of Citric acid and EDTA.

3. The composition of claim 1, wherein the pH regulator is selected from the group consisting of potassium bicarbonate and malic acid.

4. The composition of claim 1, wherein the surfactant is selected from the group consisting of Sodium Lauryl Sulfate (SLS), Sodium Lauryl Sulfoacetate (SLSA,) Sodium Laureth Sulfate (SLES,) yucca extract, Disodium Laureth Sulfosuccinate and sodium coco sulfate.

5. The composition of claim 2, wherein the composition comprises at least 10.5% of the Citric acid.

6. The composition of claim 4, wherein the composition comprises at least 5.3% of the surfactant.

7. A harvest/post-harvest composition for washing Cannabis, the composition comprising:
a solution of Tetraacetylethylenediamine (TAED) and sodium percarbonate in at least a ratio of 1:1 to 3:1 respectively;
a chelating agent;
a pH regulator; and
a surfactant;
wherein the pH regulator and the surfactant are added in a quantity as minimal as possible to avoid foaming entirely or to produce negligible foaming.

8. The composition of claim 7, wherein the chelating agent and the pH regulator is selected from the group consisting of Citric acid and EDTA.

9. The composition of claim 7, wherein the pH regulator is selected from the group consisting of potassium bicarbonate and malic acid.

10. The composition of claim 7, wherein the surfactant is surfactant is selected from the group consisting of Sodium Lauryl Sulfate (SLS), Sodium Lauryl Sulfoacetate (SLSA,) Sodium Laureth Sulfate (SLES,) yucca extract, Disodium Laureth Sulfosuccinate and sodium coco sulfate.

11. The composition of claim 8, wherein the composition comprises at least 10.5% of the Citric acid.

12. The composition of claim 10, wherein the composition comprises at least 5.3% of the surfactant.

13. A method for preparing a harvest/post-harvest composition for washing flowering plants, the method comprising:
mixing a solution of Tetraacetylethylenediamine (TAED) and sodium percarbonate in a ratio ranging from 1:1 to 3:1 respectively;
adding a chelating agent, a pH regulator and a surfactant in such a quantity to cause no or negligible foaming;
soaking the flowering plant at the time of harvest or post-harvest for at least twenty minutes; and
finally soaking the flowering plant in water for at least twenty minutes in order to initiate a reduction of microbials on the flowering plant.

14. The method of claim 13, wherein the mixing is performed in a mixer.

15. The method of claim 13, wherein the mixing is manual in a zipper bag.

16. The composition of claim 13, wherein the chelating agent is selected from the group consisting of Citric acid and EDTA.

17. The composition of claim 13, wherein the pH regulator is selected from the group consisting of potassium bicarbonate and malic acid.

18. The composition of claim 13, wherein the surfactant is surfactant is selected from the group consisting of Sodium Lauryl Sulfate (SLS), Sodium Lauryl Sulfoacetate (SLSA,) Sodium Laureth Sulfate (SLES,) yucca extract, Disodium Laureth Sulfosuccinate and sodium coco sulfate.

19. The composition of claim 16, wherein the composition comprises at least 10.5% of the chelating agent.

20. The composition of claim 18, wherein the composition comprises at least 5.3% of the surfactant.
